(19) United States
(12) Patent Application Publication
(10) Pub. No.: US 2006/0217860 A1
(43) Pub. Date: Sep. 28, 2006

(54) Lane keeping assistant apparatus

(75) Inventor: Toru Ihara, Tokyo (JP)

Correspondence Address: ROSSI, KIMMS & McDOWELL LLP., P.O. BOX 826, ASHBURN, VA, 20146-0826, US

(73) Assignee: Mitsubishi Fuso Truck and Bus Corporation, Minato-ku (JP)

(21) Appl. No.: 11/388,748

(22) Filed: Mar. 24, 2006

(30) Foreign Application Priority Data
Mar. 25, 2005 (JP) 2005-88889

(51) Int. Cl. B62D 6/00

(52) U.S. Cl. 701/41; 701/300

(57) ABSTRACT

A lane keeping assistant apparatus assists steering force when the vehicle is about to deviate from the lane to provide the driver with improved steering feeling. The lane keeping assistant apparatus includes traveling position detecting means for detecting a traveling position of a vehicle; lane center locating means for locating the width center of a lane on which the vehicle is traveling; lateral deviation amount calculating means for calculating a lateral deviation amount of the traveling position relative to the width center; a power source for providing a steering unit of the vehicle with an assist torque; assist torque determining means for determining the assist torque to be provided by the power source based on the lateral deviation amount, wherein the assist torque determining means gradually reduces the assist torque if the lateral deviation amount is being reduced by a driver's steering operation.

### BACKGROUND OF THE INVENTION

1. Field of the Invention

The present invention relates to a lane keeping assistant apparatus which assists steering force when the vehicle is about to deviate from the lane (traveling lane)

2. Description of the Related Art

Conventionally, there has been studied and developed a lane keeping assistant apparatus in which a camera placed in the vehicle acquires an image of the forward of the vehicle; the vehicle lateral position (a lateral deviation amount) relative to the lane is calculated based on the result of image processing such as lane recognition; and a steering operation by the driver is assisted such that the lateral deviation amount is reduced. Some cars already incorporate the lane keeping assistant apparatus therein. In the below description, the lane represents a lane on which the vehicle is traveling.

Such a conventional lane keeping assistant apparatus generally includes a controller (ECU) which retains a map used for determining an assist torque in accordance with a lateral deviation amount. A power source (e.g., an electric motor) is attached to the steering unit, driving the power source with an assist torque determined with reference to above map assists the driver's steering operations.

The characteristic of an assist torque determination map is properly determined by each automobile manufacturer. In Japan, with the intention that the lane keeping assistant apparatus does not obstruct a driver's steering operation in an emergency situation and is not used for a manner (such as automatic steering driving) departing from the original purpose, Japanese Ministry of Land Infrastructure and Transportation lays down a provisional technical development guideline. The guideline determines the upper assist torque (the maximum assist torque), conditions for cancelling steering assist and others. In addition, the guideline determines that steering assist (hereinafter, steering assist is identical in meaning to lane keeping assist) is performed when the vehicle is traveling on a lane with a curve diameter of 1000R or larger, the vehicle is traveling a curve of the turning clearance radius with the lateral acceleration of 0.5 m/s² or smaller, an addition steering force (an assist steering force) is 28 Nor smaller, or the lateral acceleration of the vehicle dynamics caused by an assist torque is 0.5 m/s² or smaller.

In addition to the technique of positive steering assist so that the vehicle approaches the lane width center, a technique for alerting the driver with a vibrating steering wheel when the vehicle is judged to be about to deviate from the lane (disclosed in, for example, Japanese Patent Application Publication No. 2000-251171).

Besides, there is provided a technique that measures the degree of decrease in the driver's alertness on the basis of information including a vehicle speed, steering wheel angle, accelerator depression amount, brake pedal on-off state, cultch operation state, transmission shift position, and flasher lever operation state, and then alerts the driver in accordance with the measured alertness decreasing degree (e.g., disclosure in Japanese Patent Application Publication No. HEI 7-290990).

If the driver intentionally steers such that the vehicle approaches the width lane center while the lane keeping assistant apparatus is working, the driver may feel discomfort because the assist steering force conversely obstructs the driver's steering operation.

Further, if the white lines on the both side of the vehicle cannot be recognized for some reason while the lane keeping assistant apparatus is working, sudden vanishing of the assist torque that has been acting makes the driver discomfort. On the other hand, if the white-line recognition that has been impossible becomes possible again, simple application of an assist torque also makes the driver feel discomfort.

A sudden appearance of an obstacle forward the vehicle may cause the driver to reflectively steer in order to keep out of the obstacle. There is a demand for surely detection of a driver's steering operation for emergency avoidance or for other reasons, and the working of the lane keeping assistant apparatus is cancelled not to obstruct the driver's steering operation.

With the foregoing problems and demands in view, the object of the present invention is to provide a lane keeping assistant apparatus which can realize steering feeling that does not make the driver discomfort even during the above situations.

### SUMMARY OF THE INVENTION

To attain the above object, as a generic feature, there is provided a lane keeping assistant apparatus comprising: traveling position detecting means for detecting a traveling position of a vehicle; lane center locating means for locating the width center of a lane on which the vehicle is traveling; lateral deviation amount calculating means for calculating a lateral deviation amount of the traveling position detected by the traveling position detecting means relative to the width center located by the lane center locating means; a power source for providing a steering unit of the vehicle with an assist torque; assist torque determining means for determining the assist torque that is to be provided by the power source based on the lateral deviation amount calculated by the lateral deviation amount calculating means, wherein the assist torque determining means gradually reduces the assist torque if the lateral deviation amount is being reduced by a steering operation of a driver of the vehicle.

With the lane keeping assistant apparatus, since the assist torque is being gradually reduced when the lateral deviation amount is being reduced by a steering operation of a driver of the vehicle, it is possible to realize fine steering feeling without making the driver discomfort. In addition, the present invention can realize a lane keeping assistant control which values driver's steering operations.

As a preferable feature, if the lateral deviation amount calculating means is unable to calculate the lateral deviation amount, the assist torque determining means may gradually reduce the assist torque.

This configuration can provide finer steering feeling as compared with a setting the assist torque to sharply drop to zero.

Further, as another preferable feature, if the lateral deviation amount calculating means is able to calculate the lateral deviation amount while the assist torque determining means is gradually reducing the assist torque, the assist torque determining means may gradually reduce or return the assist torque such that the assist torque becomes a suitable value for the lateral deviation amount.

As an additional preferable feature, if the lateral deviation amount is being reduced by a steering operation of the driver, the assist torque determining means may gradually reduce the assist torque in accordance with a predetermined map; and after that, if the lateral deviation amount is not being reduced by a steering operation of the driver while the assist torque determining means is gradually reducing the assist torque, the assist torque determining means may gradually reduce or return the assist torque such that the assist torque becomes a suitable value for the lateral deviation amount.

These configurations can improve steering feeling of the driver.

As a further preferable feature, the lane keeping assistant apparatus may further comprise steering state detecting means for detecting a steering direction and a steering angle of the vehicle, and calculating a steering speed based on the steering direction and the steering angle which have been detected, wherein the assist torque determining means may discontinue providing the assist torque if the absolute value of the steering speed calculated by the steering state detecting means exceeds a predetermined value.

This configuration makes it possible to surely judge the driver's steering operation for emergency avoidance during the normal assist control. Discontinuing the normal assist control under such a situation prevents the driver's steering operation to be obstructed, so that improved steering feeling can be provided to the driver and at the same time the vehicle safety can be enhanced.

Setting the predetermined value to be 55 deg/sec can judge the driver's steering operation for emergency avoidance with high accuracy.

Other objects and further features of the present invention will be apparent from the following detailed description when read in conjunction with the accompanying drawings.

### BRIEF DESCRIPTION OF THE DRAWINGS

FIG. 1 is a block diagram schematically showing the main part of a lane keeping assistant apparatus according to an embodiment of the present invention;

FIG. 2 is a diagram illustrating a structure of a steering mechanism of a vehicle to which the lane keeping assistant apparatus of FIG. 1 is applied;

FIG. 3 is a map for determining a basic assist torque used in the lane keeping assistant apparatus of FIG. 1;

FIG. 4 is a schematic diagram illustrating effect that the lane keeping assistant apparatus of FIG. 1 produces;

FIG. 5 is a torque decreasing/returning map used in the lane keeping assistant apparatus of FIG. 1;

FIGS. 6 and 7 are flow diagrams showing a succession of procedural steps performed in the lane keeping assistant apparatus of FIG. 1;

FIG. 8 is a flow diagram showing a succession of procedural steps performed in the lane keeping assistant apparatus of FIG. 1;

FIG. 9 is a flow diagram showing a sub-routine performed in the lane keeping assistant apparatus of FIG. 1; and

FIG. 10 is a flow diagram showing a routine performed in the lane keeping assistant apparatus of FIG. 1.

### DESCRIPTION OF THE PREFERRED EMBODIMENTS

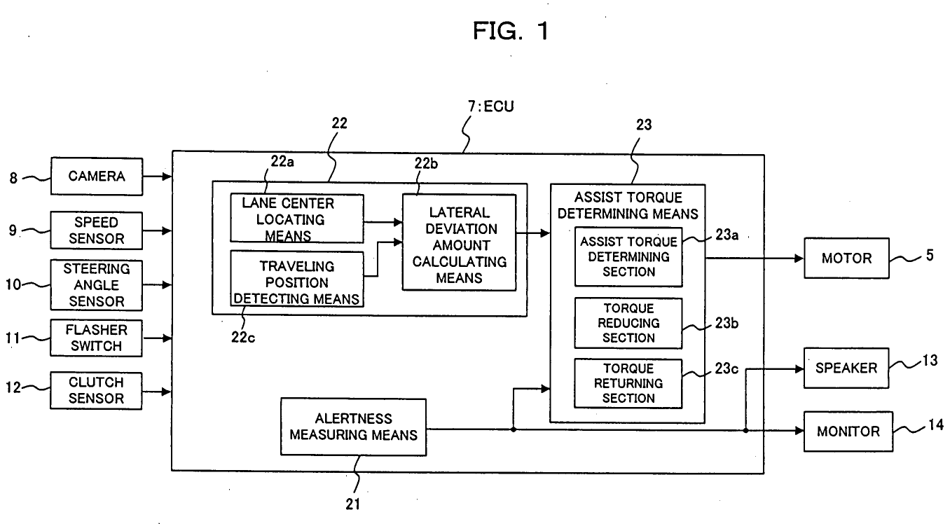

An embodiment of the present invention will now be described with reference to FIGS. 1-10. A steering unit 101 includes a steering wheel 1, a steering shaft 2, a steering gear box 3, a pitman arm 4, a motor (a power source) 5 and the like.

The steering wheel 1 is engaged with the steering box 3, which is engaged with the pitman arm 4, via the steering shaft 2. The pitman arm 4 is engaged with non-illustrated front wheels via linking mechanisms also not illustrated. Rotation of the steering wheel 1 swings and drives the pitman arm 4 and thereby steers the front wheels.

The steering shaft 2 is engaged with the motor 5 via a belt 6. Driving torque that the motor 5 generates assists steering inputs from the steering wheel 1. The motor 5 attaches to a clutch mechanism, which is however not illustrated in detail, for interruption of engagement between the motor 5 and the steering shaft 2.

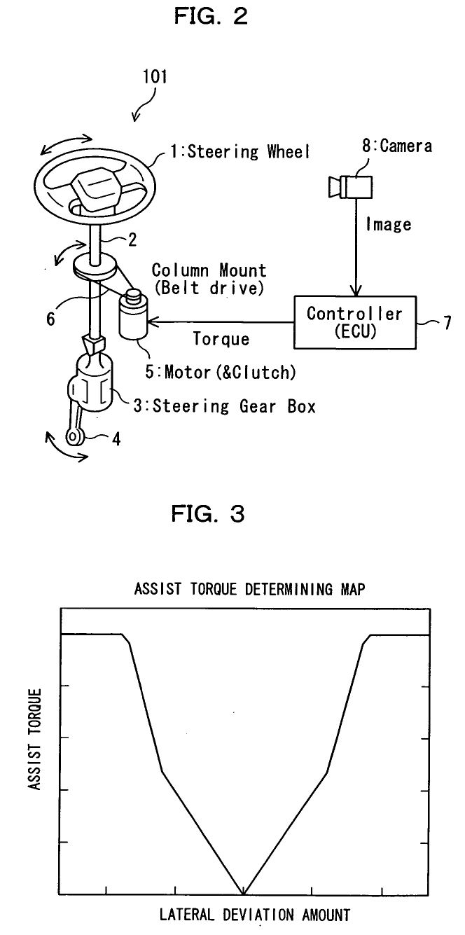

FIG. 1 is a block diagram showing the main part of the present apparatus. As shown in FIGS. 1 and 2, the motor 5 is connected to a controller (ECU, electronic control unit) 7 serving as controlling means. The operation of the motor 5 is controlled on the basis of control signals issued from the ECU 7.

Further as shown in FIG. 1, to the ECU 7 is connected to a camera 8 that is fixed to a non-illustrated position suitable for acquiring an image of the forward of the vehicle, a speed sensor 9 for measuring the traveling speed of the vehicle, a steering angle sensor (steering state detecting means) 10 for measuring a steering angle of the steering wheel 1, a flasher switch 11 for detecting operation states of left and right flashers, and a clutch sensor 12 for detecting an operation state of the clutch. Additionally, however not illustrated, an accelerator opening sensor for measuring the amount of accelerator opening or the amount of depression of the accelerator, a brake sensor for detecting an on-off state of the brake pedal, and a sensor for obtaining a shift position of the transmission are also connected to the ECU 7. Various states or information concerning the vehicle's dynamics detected by theses sensors are sent to the ECU 7.

Here, the ECU 7 calculates, on the basis of image information acquired by means of the camera 8, an amount of lateral deviation of the width center of the vehicle from the center of the lane on which the vehicle is traveling and at the same time determines an assist torque to decrease the calculated lateral deviation amount, and on the basis of information from each sensor, judges the degree of decrease in alertness of the driver and induces driver's alertness.

Hereinafter, the functional configuration of the ECU 7 will now be detailed with reference to FIG. 1. Inside the ECU 7, there are disposed alertness measuring means 21 for judging or estimating alertness of the driver, lane deviation monitoring means 22 for monitoring whether no not the vehicle is about to deviate from the lane, and assist torque determining section 23 for generating a torque on the steering wheel 1 of the vehicle on the basis of information obtained by the lane deviation monitoring means 22.

The alertness measuring means 21 estimates alertness of the driver based on the road image of the forward of the vehicle acquired by the camera 8 and information obtained by the above sensors. For example, if the alertness measuring means 21 judges meandering of the vehicle from position data of white lines, representing the lane boundary, of the road information from the camera 8 and operation data of the steering wheel 1 obtained by the steering angle sensor 10, the alertness measuring means 21 further determines whether or not the meandering is caused by dozing at wheel on the basis of flasher operation data obtained by the flasher switch 11, and determines a degree of dozing at wheel (a degree of decrease in alertness) on the basis of the amount of the meandering. In accordance with the determined degree of decrease in alertness, the alertness measuring means 21 alerts the driver by means of an alarm from a speaker 13 or warning display on a monitor 14, and notifies the assist torque determining means 23 of the determined degree of alertness decrease of the driver.

The lane deviation monitoring means 22 judges whether or not the vehicle is about to deviate from the lane based on the image information of vehicle forward obtained by the camera 8, and includes lane center locating means 22a, lateral deviation amount calculating means 22b, and traveling position detecting means 22c in the present embodiment.

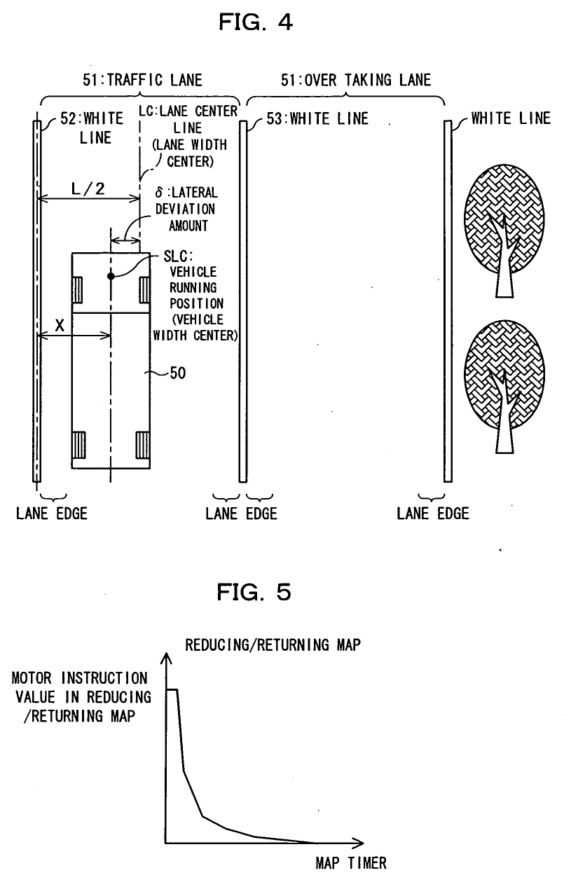

The lane center locating means 22a locates the lane width center LC of the lane 51 on which the vehicle 50 in question is traveling as shown in FIG. 4; specifically, the lane center locating means 22a recognizes the white lanes 52 and 53 on the both sides of the vehicle 50 by processing image information obtained by the camera 8 and further recognizes the region between the white lines 52 and 53 to be the lane 51 on which the vehicle 50 is traveling and locates the lane width center position LC of the recognized lane 51.

Here, when the white lines 52 and 53 are recognized, the lane center locating means 22a calculates the distance L between the white lines 52 and 53 and recognizes the position at a distance of L/2 from the left white line 53 to be the lane width center.

The traveling position detecting means 22c detects the traveling position SLC (in the present embodiment, the width center of the vehicle as shown in FIG. 4) of the vehicle based on the image information obtained by the camera 8, and calculates a distance x between the left white line 52 and the vehicle width center SLC.

The lateral deviation amount calculating means 22b calculates a lateral deviation amount δ based on the lane width center LC located by the lane center locating means 22a and the vehicle width center SLC of the vehicle 50 detected by the traveling position detecting means 22c. Specifically, the lateral deviation amount calculating means 22b calculates the lateral deviation mount 5 using the following formula (1).
δ=1/2−x (1)

Alternatively, the lateral deviation amount δ may be calculated without providing the lateral deviation amount calculating means 22b. Since, if the camera is fixed to a position at the width center of the vehicle, the vehicle width center SLC is represented by the center of an image displayed on the monitor 14. Therefore, as long as the lane width center LC can be recognized, the distance (the lateral deviation amount δ) of the center of the image obtained by the camera 8 from the recognized lane width center LC may be directly calculated (which distance is regarded as the lateral deviation amount δ).

Further alternatively, even if the camera 8 is not fixed to the position at the width center of the vehicle, the distance x1 between the center of an image displayed on the monitor 14 and the vehicle width center SLC is constant because the camera 8 fixed to the vehicle is in constant position to the vehicle width center SLC. In this case, the ECU 7 stores the distance x1 beforehand, calculates a distance x2 between the center of the image obtained by the camera 8 and the lane width center LC, and finally calculates the lateral deviation amount δ by combining the distances x1 and x2.

Methods for alertness estimation in the alertness measuring means 21, location of the lance width center LC in the lane center locating means 22a, calculation of a lateral deviation amount δ in the lateral deviation calculating means 22b, detecting of the traveling position (width center) SLC of the vehicle 50 in the traveling position detecting means 22c are known to the public, so detailed explanation will be omitted here.

The assist torque determining section 23 includes a basic torque determining section 23a for determining a torque provided from the motor 5, i.e., an assist torque that is to be input into the steering wheel 1, and a torque reducing section 23b for gradually reducing an assist torque, and an torque returning section 23c for gradually returning (increasing) the assist torque.

In the basic torque determining section 23a, there is stored a map representing a basic torque determining map (a basic map) shown in FIG. 3. With reference to the map, an assist torque in accordance with a lateral deviation amount calculated by the lateral deviation amount calculating means 22b can be calculated. This basic map sets an assist torque to become larger in accordance with increasing in the lateral deviation amount.

If reduction control and returning control that are to be described below are not being carried out, a control signal (a motor instruction value) is output to the motor 5 so that the motor 5 outputs an assist torque determined by the basic torque determining section 23a. Further, as shown in FIG. 3, the assist torque has an upper limit previously set, and steering assist in excess of the upper limit is prohibited.

In the below description, steering assistant control based on an assist torque determined by the basic torque determining section 23a is referred to as “normal steering assistant control” or “normal assistant control.”

Next, the main part of the present apparatus will now be detailed. The present apparatus carries out assist torque reduction control and assist torque returning control using assist torques determined by the torque reducing section 23b and the torque returning section 23c, respectively in addition to the above basic steering assistant control (normal assistant control).

At first, description will now be made in relation to assist torque reduction control (torque reduction control) When at least any one of the following Conditions 1-3 is satisfied, the assist reduction control is carried out in which gradually reduces the assist torque.

Condition 1: a lateral deviation amount is judged to be decreasing by a steering operation of the driver (in other words, driver's steering back is confirmed) during normal assistant control;

Condition 2: recognition of the white lines becomes impossible (in other words, calculation of a lateral deviation amount becomes impossible) during normal assistant control; and

Condition 3: conditions to execute normal assistant control are cancelled (for example, the flasher switch 11 is turned on, the vehicle speed is lower than a predetermined speed, the steering angle is larger than a predetermined angle, or the steering speed (the steering angle speed) is higher than a predetermined speed (e.g., 55 deg/sec)) during normal assistant control.

If at least one of the above conditions is satisfied, the torque reducing section 23b gradually reduces the current assist to finally become zero. The reduction is carried out because, when steering back by the driver is judged for Condition 1, the driver intentionally corrects the lateral position of the vehicle and normal assistant control is not required. Further in this case, carrying out normal assistant control may make the driver discomfort. As a solution, the normal assistant control is discontinued in the present embodiment. In addition, since the driver may feel discomfort if the assist torque is set to suddenly drop to zero in such a case, the present invention sets the assist torque to gradually decrease.

Conditions 2 and 3 are set as conditions not to execute the normal assistant control. In particular, in relation to Condition 3, when the flasher switch 11 is on, the ECU 7 can estimates that the driver intentionally carries out a steering operation; and when the vehicle speed is lower than the predetermined speed, the ECU 7 can estimates that the driver reduces the vehicle speed to stop the vehicle. A steering angle (the absolute value thereof) larger than the predetermined angle can be regarded as a result of driver's intension; and a steering speed (the absolute value thereof) higher than the predetermined speed can be regarded as a result of an emergency avoidance operation done by the driver.

If Condition 2 or 3 is satisfied during normal assistant control, carrying out steering assist may obstruct a steering operation of the driver. For this reason, steering assist is suspended and an assist torque is gradually reduced.

As mentioned above, a steering speed faster than 55 deg/sec is judged to be an emergency avoidance operation by the driver in the present embodiment. The threshold value 55 deg/sec is set for the following reasons.

First of all, the steering characteristic of a driver when driving a straight road is assumed to be represented by a sine curve (sine wave) for simplification. Further, the steering angle caused by a steering operation by the driver is assumed to be 15 deg or smaller. Inventors' experiment has found that the corrective steering frequency of a driver is as large as approximately 0.1-0.6 Hz when driving on a highway.

Under these assumptions, a driver's steering angle has the highest variation ratio when a corrective steering frequency is 0.6 Hz, and the maximum value of the concurrent steering speed is 55 deg/sec. Therefore, a steering speed higher than 55 deg/sec is judged to be a result of a driver's steering operation for emergency avoidance, and the normal assistant control is discontinued in the present embodiment.

The steering angle operated by the driver is assumed to be 15 deg or smaller partly because the effective steering angle of the present lane keeping assistant apparatus according to the present embodiment is 15 deg or smaller and partly because Japanese Ministry of Land Infrastructure and Transportation provisionally sets an effective steering angle of 15 deg or smaller in the technical instruction that has been disclosed.

In other words, the technical instruction determines that steering assistant control operates in the range less than 0.05G (0.5 m/s²) when driving a curve of 1000R or larger. Since a general steering gear ratio for tracks and buses is set to be approximately 17-23, the steering angle when driving on a highway at 80 km/h is +/−15 deg, which corresponds to an actual tire steering angle less than 1 deg. The wheelbase of an ordinary track is approximately 3.0-7.2 m, and a tire steering angle of about 0.4 deg is geometrically required to turn a curve of 1000 R.

Since the steering characteristic of the most vehicles is set to be understeer, a higher vehicle speed requires a larger steering angle. Therefore, an actual steering angle is as large as approximately 1 deg, which is larger than 0.4 degree, when the vehicle is running, and the maximum steering angle is approximately 15 degree so that the vehicle turns a curve of 1000R.

Next, description will now be made in relation to the torque reducing section 23b. The torque reducing section 23b retains a torque reducing/returning map shown in FIG. 5, which map outputs a motor instruction value when torque reduction control is being carried out.

Specifically, when at least one of the above Conditions 1-3 are satisfied, the torque reducing section 23b detects the concurrent motor instruction value and obtains a map time corresponding to the motor instruction value with reference to the map of FIG. 5. From then on, the map time corresponding to the concurrent motor instruction value is regarded as a starting point, and the map time is counted by adding a map time. Finally, the torque reducing section 23b sequentially obtains motor instruction values corresponding to the counted map times with reference to the map of FIG. 5 and outputs the obtained motor instruction values to the motor 5.

As shown in FIG. 5, the torque reducing/returning map sets the characteristic of the motor instruction value to reduce as the map time increases (the motor instruction value increases as the map time decreases). Accordingly, the assist torque gradually reduces in accordance with increase in the map time.

If the normal control is to restart while the normal assist control is being discontinued or the above reduction control is being performed, the torque returning section 23c carries out returning control which gradually increases or decreases the assist torque, and after that the returning control is replaced by the normal assist control.

For example, when the white lines 52 and 53 and/or the lateral deviation amount δ which have not been recognized or calculated due to a disturbance, a road state or other reason can be recognized or calculated, sudden output of an assist torque corresponding to the lateral deviation amount δ may make the driver discomfort. As a solution, the present invention execute control to fluctuate an assist torque such that the assist torque gradually approaches a suitable assist torque for the lateral deviation amount δ.

When the reduction control is replaced by the returning control, the assist torque of the final object corresponding the lateral deviation amount δ may be smaller than the current assist torque. In this case, the torque returning section 23c carries out the returning control in which the current assist torque is gradually reduced.

Here, the torque returning section 23c also retains the torque reducing/returning map shown in FIG. 5. In other words, the torque reducing section 23 band the torque returning section 23c uses the same map in the present embodiment, and a motor instruction value is output from the map to the motor 5 during the torque returning control.

Specifically, during torque returning control, a suitable motor instruction value (object value) for the lateral deviation amount is obtained and, if the object motor instruction value is lager than the current motor instruction value, the map time corresponding to the current motor instruction value is regarded as the base point with which the map time is counted by performing subtractions. After that, the motor instruction value corresponding to each counted map time is obtained with reference to the map of FIG. 5 and is sequentially output to the motor 5. On the other hand, if the object motor instruction value is lower than the current motor instruction value, the map time is counted by performing additions and each corresponding motor instruction value is sequentially output.

With the torque reducing section 23b and the torque returning section 23c, the present invention can provide the driver with steering feeling free from discomfort even if recognition of the white lines becomes impossible or then becomes possible again.

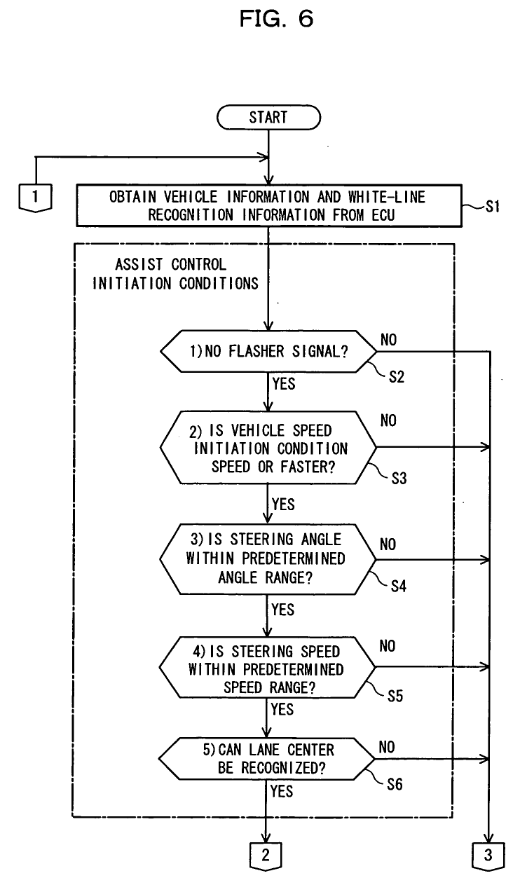

The lane keeping assistant apparatus of the present embodiment has the above configuration, and the main operation performed by the apparatus will now be detailed. First of all, the apparatus obtains information from the various sensors and white line recognition information (e.g., image information from the camera 8) at step S1 of FIG. 6.

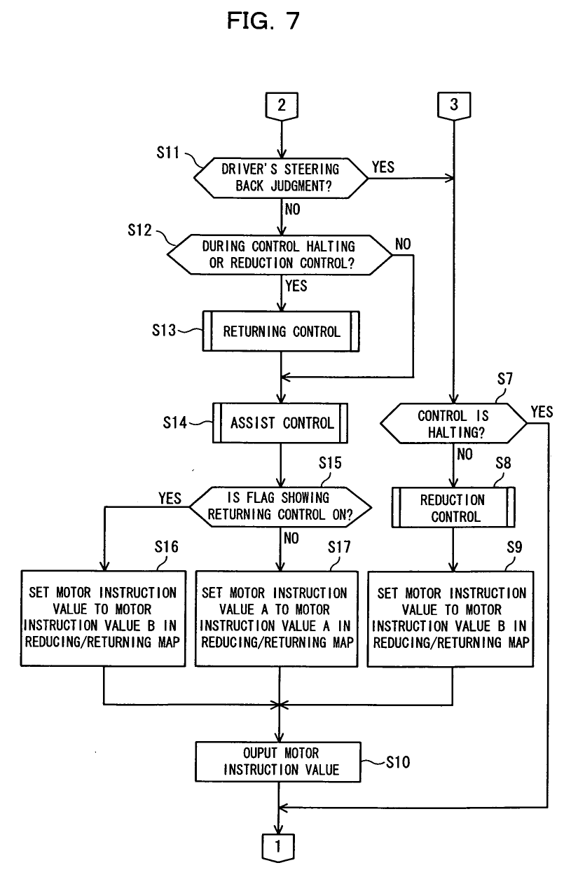

Next, judgment is made as to whether or not normal steering assist control (i.e., the normal assist control) by the present apparatus can be carried out at steps S2-S6. Specifically, step S2 judges whether or not the flasher switch 11 is off; step S3 judges whether or not the vehicle speed is a predetermined speed that satisfies the initiation condition for steering assist control or faster; step S4 judges whether or not the steering angle is a predetermined angle or smaller; step S5 judges whether or not the steering speed is a predetermined speed or lower; and step S6 judges whether or not the lane width center can be recognized from the image taken by the camera 8. If at least one result in judgments in steps S2-S6 is negative, the succession of procedural steps proceeds to step S7 in FIG. 7 to suspend or stop the normal assist control.

If step S2 judges that the flasher switch 11 is on, there is high possibility that the driver intentionally steers and therefore the normal assist control is suspended or stopped not to disturb the driver's steering. Further, if step S4 judges that the steering angle is larger than the predetermined angle, the driver's intentionally steering is also admitted and the normal assist control is therefore suspended or stopped.

In the case where the vehicle speed is judged to be lower than the predetermined speed in step S3 or recognition of the lane width center is judged to be impossible in step S6, the case is not a state in which the normal assist control is performed originally and the normal assist control is therefore suspended or stopped. Further, if the steering speed is judged to be faster than the predetermined steering speed in step S5, the driver's steering is regarded as an emergency avoidance operation and the normal assist control is suspended or stopped.

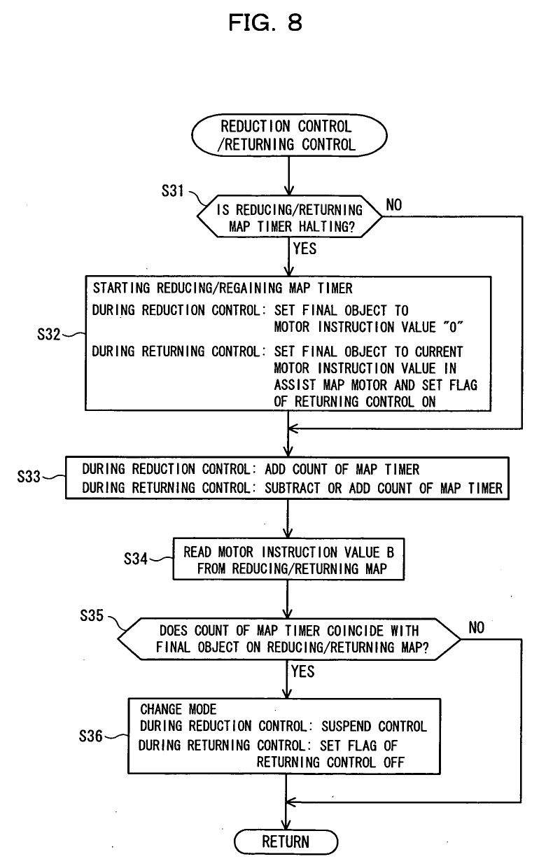

At step S7, judgment is made as to whether or not the normal assist control has been already suspended or stopped. If the result of the judgment at step S7 is positive, the procedure returns to step S1. Conversely, if the result of the judgment at step S7 is negative, i.e., if step S7 judges that the normal assist control is being carried out, the succession of the procedural steps proceeds to step S8 in which a sub-routine of the assist torque reduction control (see FIG. 8) to gradually reduce the assist torque is carried out as a substitute for the normal assist control. In the ensuing step S9, the motor instruction value B (corresponding to the assist torque generated in the motor 5) is obtained with reference to the reducing/returning map of FIG. 5, and the motor instruction value B obtained in step S9 is output to the motor 5 in step S10.

If all the results of judgments made in steps S2-S6 are positive, the procedure proceeds to step S11 to judge driver's steering back. Here, judgment on driver's steering back is judgment as to whether or not the lateral deviation amount is reduced by a driver's intentional steering operation. The steering-back judgment concludes that the driver steers to cause the vehicle width center SLC to approach the lane width center LC, the succession of the procedural steps takes the Yes route from step S11 to step S7, and if the result of the steering-back judgment is negative, the procedure proceeds to step S12.

Hereinafter, an example of a manner for judging driver's steering-back will now be described with reference to sub-routine in flow diagram FIG. 10. In this driver's steering-back judgment, the lane edge judgment is performed in which whether or not the lateral deviation amount δ is a predetermined amount or more in step S41. The vehicle 50 with the lateral deviation amount δ of a predetermined amount or more is judged to be at the edge of the lane.

If the lateral deviation amount 6 is judged to be less than the predetermined amount, the succession of the procedural steps takes the No route to reach step S42 and the driver's is judged not to steer back (negative result of driver's steering back).

If the lateral deviation amount 6 is judged to be the predetermined value or larger at step S41, the succession of the procedural steps takes the Yes route to proceed to step S43 in which the largeness of the current lateral deviation amount is compared with that of the lateral deviation amount of a predetermined time before (e.g., 0.2 second before), so that judgment is made as to whether the lateral deviation amount is increasing or decreasing.

If the lateral deviation amount is reducing (the lateral deviation amount of 0.2 second before>the current lateral deviation amount), the succession of the procedural steps takes the Yes route to reach S44 which concludes that the driver steers back (the positive result on driver's steering back judgment). Conversely, if the lateral deviation amount is increasing (the lateral deviation amount of 0.2 second before≦the current lateral deviation amount), the succession of the procedural steps takes the No route to reach S43 which concludes that the driver does not steer back (the negative result on the driver's steering back judgment).

If the result of the driver's steering back judgment at step S11 in FIG. 7 is positive and the succession of the procedural steps proceeds to step S7, step S7 judges whether or not the normal assist control is stopped. The positive result in step S7 returns the procedure to step S1. If the result of judgment is negative, the procedure proceeds to step S8 to carry out sub-routine of the reduction control in which the assist torque is gradually reduced.

In other words, since the positive result of steering back judgment means that driver is steering so that the vehicle width center SLC approaches the lane width center LC, it is contemplated that the driver intentionally corrects the vehicle lateral position. In this case, there is no need to carry out the normal assist control. Further, execution of assist control may make the driver discomfort. Therefore, the normal assist control is stopped by gradually reducing the assist torque.

On the other hand, if the result of the driver's steering back judgment at step S11 is negative, i.e., the driver is judged not to steer so that the vehicle width center SLC approaches the lane width center LC, the procedure proceeds to step S12 and judgment as to whether or not the normal assist control has been stopped or reduction control that gradually reduces the assist torque is being carried out. If the result of the judgment is positive, the succession of the procedural steps proceeds to step S13 to carry out the sub-routine (see FIG. 8) of the assisttor quereturning control. In other words, step S13 does not suddenly output the necessary assist torque but sets an assist torque (motor instruction value B) such that the assist torque is fluctuated not to make the driver discomfort. If the result of the judgment at step S12 is negative (i.e., while the normal assist control is currently being carried out), the procedure directly proceeds to step S14 from step S12.

Hereinafter, description will now be made in relation to reduction control performed at step S8 and the returning control performed at step S13 with reference to flow diagram FIG. 8. The present embodiment carries out the reduction control and the returning control using the same map and the same flow diagram. Alternatively, the reduction control and the returning control may be performed using different maps and flow diagrams.

First of all, whether or not the reducing/returning map timer is stopped is judged at step S31. When the judgment at step S31 for the first time since the procedure has entered this sub-routine, the timer is stopped and the procedure proceeds to step S32 via the Yes route.

In step S32, the reducing/returning map timer is started. The reducing/returning map timer is set to increase the count as the reduction control and to decrease the count as the returning control. In other words, in the event of reduction control, the motor instruction value at the starting time of the reduction control is obtained and, on the basis of the reducing/returning map shown in FIG. 5, the map time (count starting point) corresponding to the obtained motor instruction value is obtained. When returning control is to be carried out, a motor instruction value at the starting time of the returning control is obtained and, on the basis of the reducing/returning map shown in FIG. 5, the map time (count starting point) corresponding to the obtained motor instruction value is obtained. Further, a map time (count finishing point) corresponding to the motor instruction value determined by the basic torque determining section 23a is obtained Even during the returning control, if the object motor instruction value is smaller than the current motor instruction value, the count of the timer increases and the assist torque is gradually reduced. Further, a returning control flag is set on at step S32 when the returning control is being carried out.

In the ensuing step S33, addition or subtraction of the count of the timer starts. Then, in step S 34, the motor instruction value is sequentially read from the reducing/returning map, which value is regarded as the motor instruction value B. Whether or not counting of the map timer is finished is judged, and if the result of the judgment is negative, the procedure terminates.

Upon completion of counting of the map timer, the succession of the procedural steps proceeds to step S36 from step S35 and, if the reduction control is being curried out, the reduction control finishes to complete or discontinue control by the present apparatus. On the contrary, the flag showing the returning control is switched to off.

Repetitiously performing this sub-routine gradually reduces the motor torque instruction value by increasing the count of the map timer based on the map of FIG. 5 as reduction control. As the returning control, decrease in the count of the timer gradually increases the motor torque instruction value conversely to the reduction control.

Here, description is continued with reference back to FIG. 7. The motor torque instruction value B for the returning control is obtained at step S13 and the procedure proceeds to step S13, in which the motor torque instruction value A for the normal assist control is obtained. If the result of the judgment at step S12 is negative (i.e., during the normal assist control), the succession of the procedural steps directly proceeds to step S14 from the step S12 to read the motor instruction value A for the normal assist control.

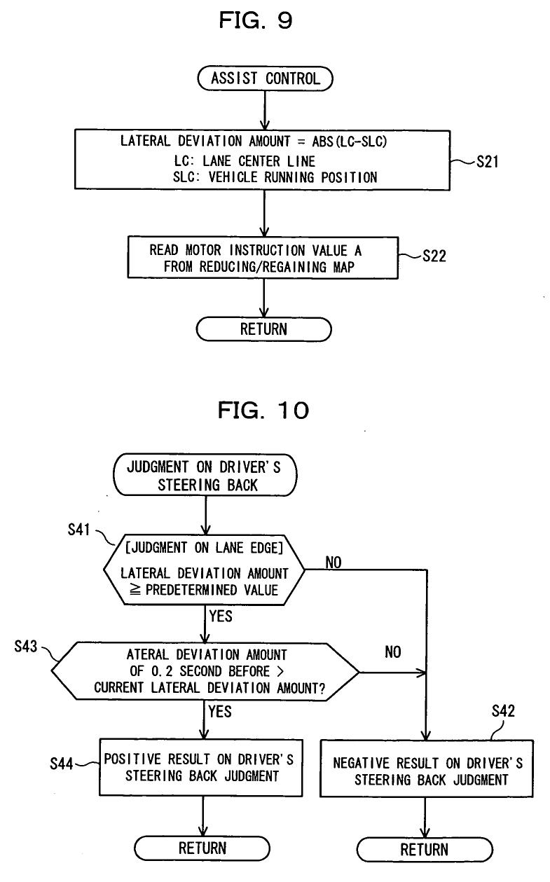

Here, the motor instruction value A used as normal assist control is obtained by carrying out the sub-routine of FIG. 9. First of all, the lateral deviation amount δ of the vehicle width center SLC from the lane width center LC is calculated in step S21. Then the instruction value A to the motor 5 is read from the basis assist torque determining map shown in FIG. 3 (step S22).

Description will be continued with reference back to FIG. 7. When the motor instruction value A for the normal assist control is read in step S14, whether or not a flag indicating the returning control is on is judged in step S15. As described above, the flag indicating the returning control is turned on in step S32 if the returning control is carried out. If the flag of the returning control is on, the procedure takes the Yes route to reach step S16 in which the motor instruction value B for the returning control, which value has been read in step S13, is set to be the motor instruction value and is output to the motor 5 in step S10.

Conversely, if the flag of the retuning control is off, the procedure takes the No route to reach step S17 in which the motor instruction value A for the normal assist control, which value has been read in step S14, is set to be the motor instruction value A and is output to the motor 5 in step S10.

Repetitiously carrying out the succession of the procedural steps can greatly improve steering feeling that the driver has during driving under the present lane keeping assistant control.

In other words, since the lane keeping assistant apparatus of the present embodiment gradually reduces the assist torque when driver's steering operation reduces the lateral deviation amount δ, it is possible to realize the fine steering feeling without making the driver discomfort. Further advantageously, it is possible to realize the lane keeping assistant control which values driver's steering operations.

In addition, when calculation of a lateral deviation amount δ becomes impossible, the present apparatus gradually reduces the assist torque and the driver has the better steering feeling than the case where the assist torque is set to suddenly drop to zero. If calculation of a lateral deviation amount δ becomes possible, the present apparatus gradually reduces or returns the assist torque such that the assist torque becomes a suitable value for the lateral deviation amounts whereby the steering feeling can be improved.

Since the present apparatus can accurately judge a driver's steering operation for emergency avoidance and at that time the normal assist control is suspended, the driver's emergency steering operation is not obstructed and the driver has finer steering feeling. Advantageously, the vehicle safety can be also improved.

Further, the present invention should by no means be limited to the foregoing embodiment, and various changes or modifications may be suggested without departing from the gist of the invention. For example, judgment on driver's steering back should by no means be limited to the example described above. Alternatively, a steering torque input by the driver may be detected and the judgment may be made based on the detected steering torque. Further, an assist torque may be gradually reduced or increased by various known methods other than by controlling with reference to the map of FIG. 5 as described in the present embodiment.

What is claimed is:

1. A lane keeping assistant apparatus comprising:
traveling position detecting means for detecting a traveling position of a vehicle;
lane center locating means for locating the width center of a lane on which the vehicle is traveling;
lateral deviation amount calculating means for calculating a lateral deviation amount of the traveling position detected by said traveling position detecting means relative to the width center located by said lane center locating means;
a power source for providing a steering unit of the vehicle with an assist torque;
assist torque determining means for determining the assist torque that is to be provided by said power source based on the lateral deviation amount calculated by said lateral deviation amount calculating means, wherein said assist torque determining means gradually reduces the assist torque if the lateral deviation amount is being reduced by a steering operation of a driver of the vehicle.

2. A lane keeping assistant apparatus according to claim 1, wherein, if said lateral deviation amount calculating means is unable to calculate the lateral deviation amount, said assist torque determining means gradually reduces the assist torque.

3. A lane keeping assistant apparatus according to claim 2, wherein, if said lateral deviation amount calculating means is able to calculate the lateral deviation amount while said assist torque determining means is gradually reducing the assist torque, said assist torque determining means gradually reduces or returns the assist torque such that the assist torque becomes a suitable value for the lateral deviation amount.

4. A lane keeping assistant apparatus according to claim 2, wherein:
if the lateral deviation amount is being reduced by a steering operation of the driver, said assist torque determining means gradually reduces the assist torque in accordance with a predetermined map; and
after that, if said lateral deviation amount is not being reduced by a steering operation of the driver while said assist torque determining means is gradually reducing the assist torque, said assist torque determining means gradually reduces or returns the assist torque such that the assist torque becomes a suitable value for the lateral deviation amount.

5. A lane keeping assistant apparatus according to claim 1, further comprising steering state detecting means for detecting a steering direction and a steering angle of the vehicle, and calculating a steering speed based on the steering direction and the steering angle which have been detected, wherein
said assist torque determining means discontinues providing the assist torque if the absolute value of the steering speed calculated by said steering state detecting means exceeds a predetermined value.

6. A lane keeping assistant apparatus according to claim 5, wherein the predetermined value is 55 deg/sec.
